(19) United States
(12) Patent Application Publication
(10) Pub. No.: US 2001/0038059 A1
(43) Pub. Date: Nov. 8, 2001

(54) Flexible tube forming clamp

(76) Inventors: Brett A. Dick, New Haven, IN (US); Glen D. Snyder, New Haven, IN (US)

Correspondence Address: INTERNATIONAL TRUCK AND ENGINE CORPORATION, SUITE 1300, 455 N CITYFRONT PLAZA DRIVE, CHICAGO, IL, 60611, US

(21) Appl. No.: 09/781,936

(22) Filed: Feb. 12, 2001

Related U.S. Application Data
(60) Provisional application No. 60/181,821, filed on Feb. 11, 2000.

(51) Int. Cl. F16L 3/08

(52) U.S. Cl. 248/65; 248/74.1

(57) ABSTRACT

A clamp for holding flexible tubing or hose at a specific angle; while useful in many applications, the flexible tube-forming clamp is particularly useful in automotive or other mobile vehicle applications. The clamp defines a specific turn radius for the tubing or hose without having to completely or nearly encircle the hose or clamp to hold it in position. The method of achieving these specific angles or bends is by using counter acting hose or tubing receiving members that act in opposing directions on the hose as a result of the bend radius and the natural tendency of the hose or clamp to flex back to a straight line.

This is a non-provisional patent application claiming the priority of provisional patent application Ser. No. 60/181,821, filed Feb. 11, 2000.

### BACKGROUND OF INVENTION

This invention relates to a clamp for holding flexible tubing or hose at a specific angle. While useful in many applications, the flexible tube-forming clamp is particularly useful in automotive or other mobile vehicle applications. The clamp defines a specific turn radius for the tubing or hose without having to completely or nearly encircle the hose or clamp to hold it in position. The method of achieving these specific angles or bends is by using counter acting hose or tubing receiving members that act in opposing directions on the hose as a result of the bend radius and the natural tendency of the hose or clamp to flex back to a straight line.

### SUMMARY OF INVENTION

A primary object of the invention is to provide a forming clamp for holding a flexible hose or tube that has a natural tendency to flex back to a straight line in at an angle. A second object of the invention is to provide a clamp that does not need to completely or nearly encircle the flexible hose or tubing held at an angle.

The objects of the invention are satisfied by having a base member that defines a desired angle or bending radius of hosing or tubing to be held in position. Engaged to the base member are counter acting hose or tubing receiving members that act in opposing directions on the hose as a result of the bend radius and the natural tendency of the hose or clamp to flex back to a straight line.

### DRAWINGS

Other objects and advantages of the invention will become more apparent upon perusal of the detailed description thereof and upon inspection of the drawings, in which:

FIG. 1 is a perspective of a first embodiment of a flexible tube forming clamp made in accordance with this invention, with the rack in its permanent installed location.

FIG. 2 is a top down view of a second embodiment of a flexible tube forming clamp made in accordance with this invention, with the rack in its permanent installed location.

FIG. 3 is a front perspective view of the flexible tube forming clamp of FIG. 2.

FIG. 4 is a side perspective view of the flexible tube forming clamp of FIG. 2.

FIG. 5 is a top down perspective of a third embodiment of a flexible tube forming clamp made in accordance with this invention, with the rack in its permanent installed location.

FIG. 6 is a front perspective view of the flexible tube forming clamp of FIG. 5.

### DETAILS OF INVENTION

Flexible tube forming clamps made under this invention will generally contain a base member that defines a desired angle or bending radius of hosing or tubing to be held in position. Engaged to the base member are counter acting hose or tubing receiving members that act in opposing directions on the hose as a result of the bend radius and the natural tendency of the hose or clamp to flex back to a straight line.

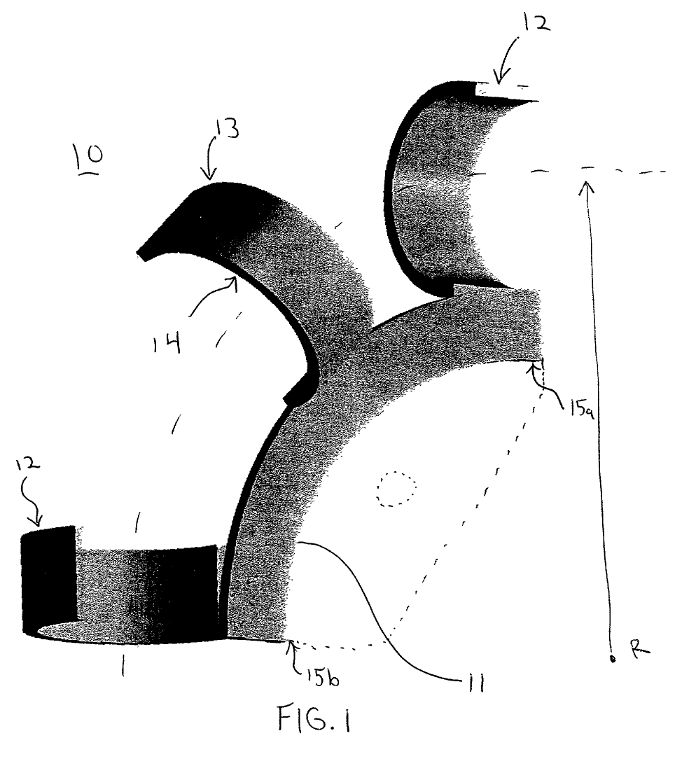

FIG. 1 illustrates one embodiment of a flexible tube forming clamp 10 made in accordance with this invention. The flexible tube forming clamp 10 has a base 11 that defines the desired angle or bending radius of hosing or tubing 19 to be held in position. In this embodiment, there are at least three counter acting hose or tubing receiving members engaged to the base: two outer receiving members 12 and one inner receiving members 13. Both the outer receiving members 12 and the inner-receiving members 13 have inner curved receiving areas 14 that are slightly smaller or approximate the outer radius of the tubing or hosing 19. The curved receiving areas 14 are of engaging arcs are not necessarily sufficient to hold or engage to the tubing or hosing alone. The engaging arcs may in some embodiments be as small an engaging arc less than or equal to 180 degrees around. The outer receiving members 12 and the inner receiving members 13 are capable of holding the tubing or hosing 19 rigidly at an angle due to their relative engagement orientation on the base 11. Using the embodiment shown in FIG. 1, the inner curved receiving areas 14 of the outer receiving members 12 are directed in one direction perpendicular to a line defining the turning radius of the base 11. The inner curved receiving areas 14 of the inner-receiving member 13 is directed in the opposite direction of those of the outer receiving members 13. This results on opposing forces upon a flexible tubing or hosing 19 to be held on a particular turning radius. The fact that the inner receiving areas 14 may not be sufficient to engage to the flexible tubing makes insertion of the tubing 19 relatively easy. The generally opposing orientation of the outer receiving members 12 to the inner receiving member 13 will force tubing 19 forced into a curve to seat against the inner receiving areas 14 of the respective receiving members. The tubing or hose 19 will thus be held at the desired turning radius. This turning radius is defined by the relative position of the outer receiving members 12 to the inner-receiving member 13. The outer receiving members are generally at opposite end locations 15a and 15b on the base 11 or at a minimum at the outer ends of the desired turning radius for the tubing 19. The inner receiving members 13 are engaged approximately at the center of the desired turning radius.

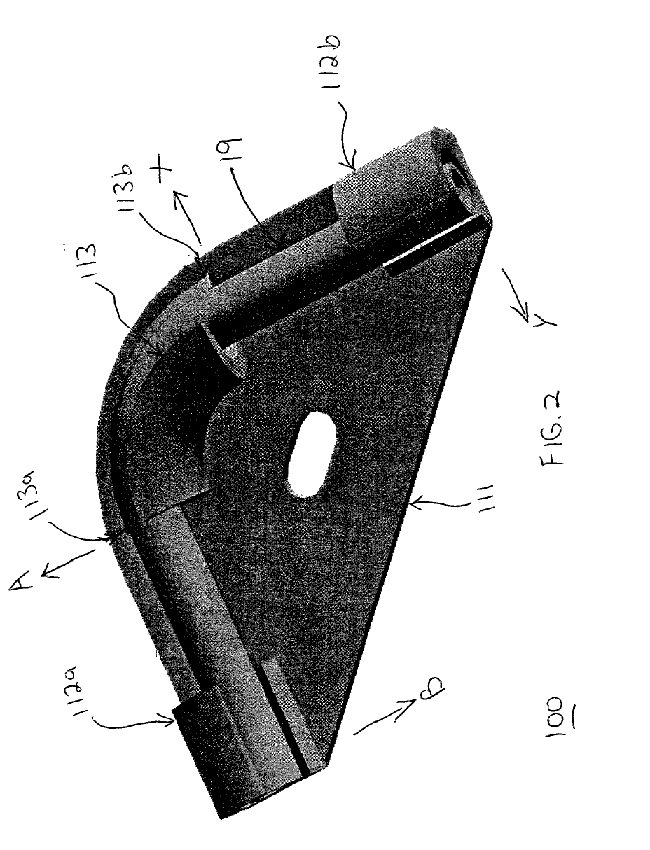

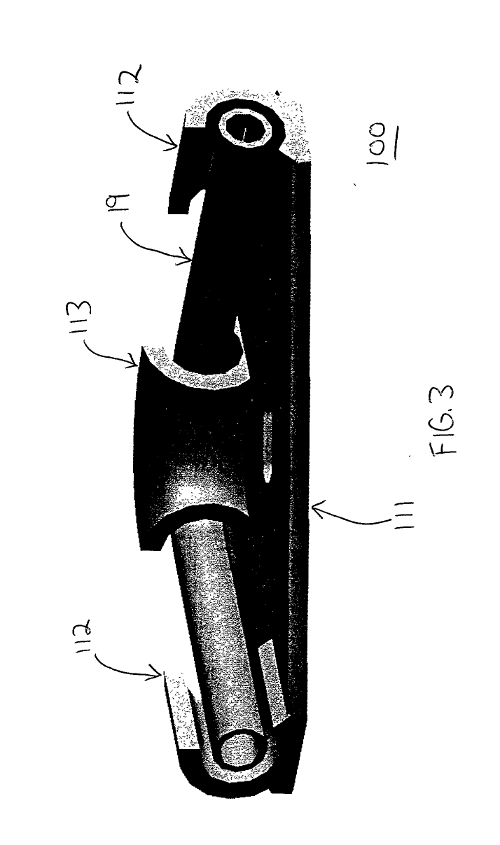

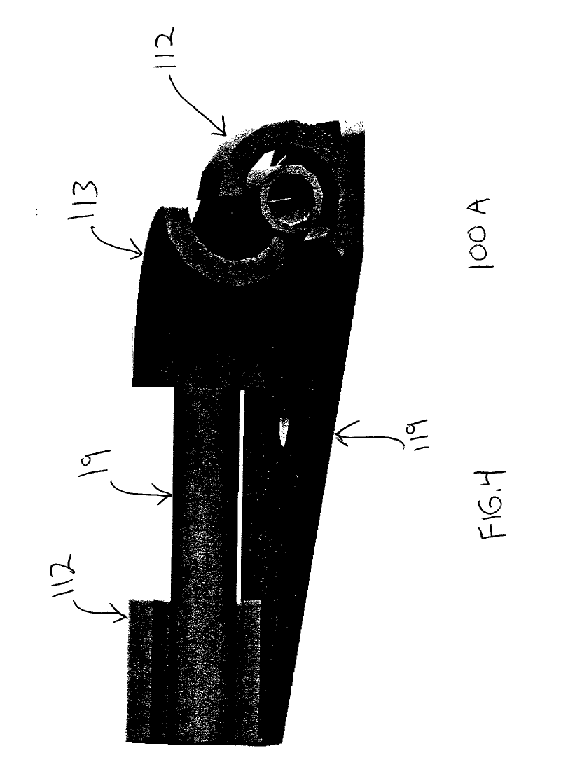

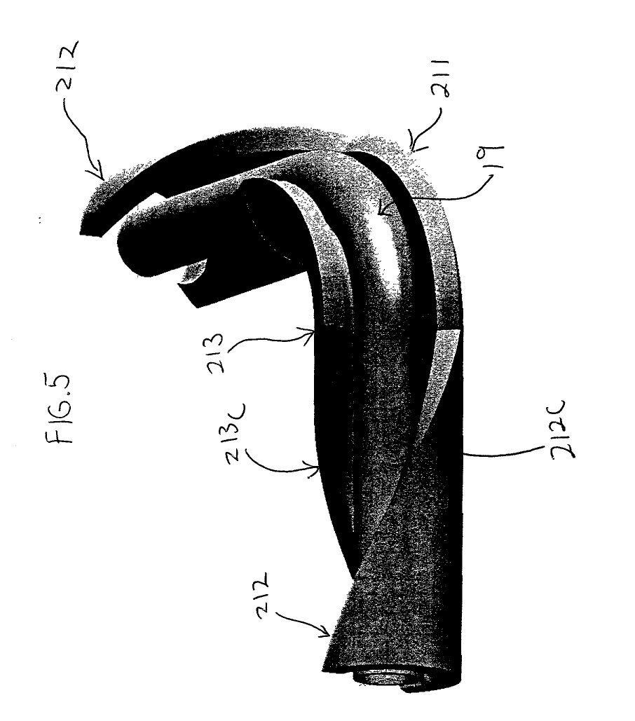

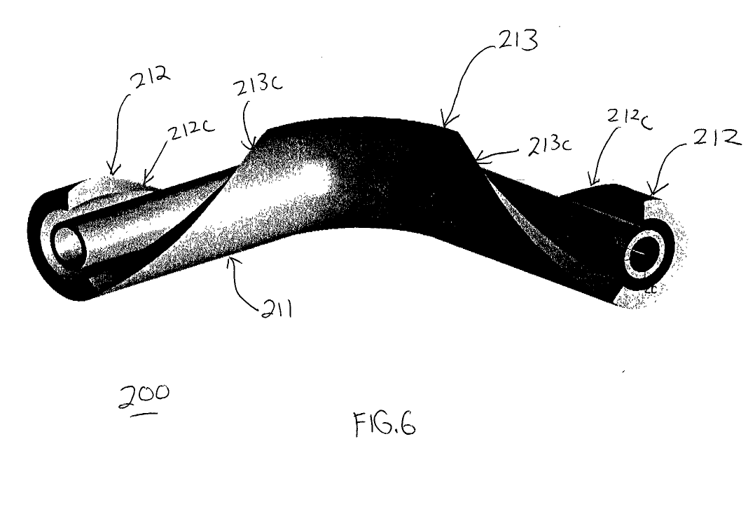

A second embodiment of a flexible tube forming clamp 100 is shown in FIGS. 2 through 4 and a third embodiment of a flexible tube forming clamp 200 is shown in FIGS. 5 and 6. The second embodiment clamp 100 differs from the first embodiment clamp 10 in that an inner receiving member 113 is curved along the receiving path of the tubing or hosing to allow enhanced seating of the tubing 19. As a result of the curvature of the inner receiving member 113, there are differences as far as the relative orientation with first outer receiving member 112a and second outer receiving member 112b. The inner receiving area on a first side end 113a of the inner receiving member 113 is directed in direction A that is opposite of an inner receiving area of the first outer receiving member 112a that is directed in direction B. The inner receiving area on a second side end 113b of the inner receiving member 113 is directed in direction X that is opposite of an inner receiving area of the second outer receiving member 112b that is directed indirection Y. Direction A and X are different due to the curvature of the inner receiving member 113.

The third embodiment clamp 200 shown in FIGS. 5 and 6 is different in that there are smooth transition curves 212c and 213c reducing the engaging arc and hence surface area of the inner receiving areas in both the outer receiving members 212 and the inner receiving member 213. These transition curves 212c and 213c allow for easier insertion of flexible hose or tubing 19 without significantly reducing the holding force of the clamp 200.

The clamps may be single integrated piece or separate components engaged together. The third embodiment flexible tube forming clamp 200 is shown as an integrated piece in the attached FIGS. 5 and 6.

As described above, the tube forming clamps provide a number of advantages, some of which have been described above and others that are inherent in the invention. Also modifications may be proposed to the tube forming claimps without departing from the teachings herein.

We claim:

1. A flexible tube forming clamp for holding hosing in a defined position, comprising:
a base member that defines a desired angle of the hosing to be held;
counter acting hose receiving members engaged to said base member that act in opposing directions on a hose when engaged to each said receiving member; and
said receiving members having inner curved receiving areas having cross sectional engagement arcs of less than 270 degrees around.

2. The tube forming clamp of claim 1, wherein there are at least three counter acting hose receiving members.

3. The tube forming clamp of claim 2, wherein said hose receiving members having inner curved receiving areas having cross sectional arcs of less than or equal to 180 degrees around.

4. A flexible tube forming clamp for holding hosing in a defined position, comprising:
a base member that defines a desired angle of the hosing to be held;
counter acting hose receiving members engaged to said base member and that act in opposing directions on a hose when engaged to each said receiving member;
there are at least three counter acting hose receiving members, two outer receiving members engaged at opposite ends of said base member and one inner receiving member engaged to said base member in a region between said outer receiving members; and
said hose receiving members have inner curved receiving areas having cross sectional arcs not sufficient to hold the tubing alone.

5. The tube forming clamp of claim 4, wherein
said cross sectional arcs being of less than 270 degrees around.

6. The tube forming clamp of claim 5, comprising said hose receiving members and said base member being a single integral piece.

7. The tube forming clamp of claim 5, wherein:
said inner curved receiving areas of said outer receiving members being directed in a direction perpendicular to a line defining a turning radius of said base member.

8. The tube forming clamp of claim 7, wherein:
said inner curved receiving areas of the inner-receiving member being directed in a direction opposite of said outer receiving members.

9. The tube forming clamp of claim 8, wherein said hose receiving members and said base member being a single integral piece.

10. The tube forming clamp of claim 9, wherein said single integral piece including said hose receiving members and said base member being made of a plastic.

11. The tube forming clamp of claim 10, comprising said inner receiving members being engaged approximately center of a desired turning radius of said base member.

12. A flexible tube forming clamp for holding hosing in a defined position, comprising:
a base member that defines a desired angle of the hosing to be held;
counter acting hose receiving members that act in opposing directions on a hose when engaged to each said receiving member;
there are at least three counter acting hose receiving members, two outer receiving members engaged at opposite ends of said base member and one inner receiving member engaged to said base member in a region between said outer receiving members;
said hose receiving members have inner curved receiving areas having cross sectional arcs not sufficient to hold the tubing alone; and
said inner receiving member is curved along a receiving path for the hosing.

13. The tube forming clamp of claim 12, wherein
said cross sectional arcs being of less than 270 degrees around.

14. The tube forming clamp of claim 13, wherein said hose receiving members and said base member being a single integral piece.

15. The tube forming clamp of claim 12, wherein:
said inner curved receiving areas of said outer receiving members being directed in a direction perpendicular to a line defining a turning radius of said base member.

16. The tube forming clamp of claim 15, wherein:
said inner curved receiving areas of the inner-receiving member being directed in a direction opposite of said outer receiving members.

17. The tube forming clamp of claim 16, wherein said hose receiving members and said base member being a single integral piece.

18. The tube forming clamp of claim 17, wherein said single integral piece including said hose receiving members and said base member being a plastic.

19. The tube forming clamp of claim 18, comprising said inner receiving members being engaged approximately center of a desired turning radius of said base member.

20. A flexible tube forming clamp for holding hosing in a defined position, comprising:
a base member that defines a desired angle of the hosing to be held;
counter acting hose receiving members that act in opposing directions on a hose when engaged to each said base member;
there are at least three counter acting hose receiving members, two outer receiving members engaged at opposite ends of said base member and one inner receiving member engaged to said base member in a region between said outer receiving members;
said hose receiving members have inner curved receiving areas having cross sectional arcs not sufficient to hold the tubing alone; and
said inner receiving areas having smooth transition curves reducing an engaging arc of said inner receiving members.

21. The tube forming clamp of claim 21, wherein said inner receiving member is curved along a receiving path for the hosing.

22. The tube forming clamp of claim 21, wherein
said cross sectional arcs being of less than 270 degrees around.

23. The tube forming clamp of claim 22, wherein said hose receiving members and said base member being a single integral piece.

24. The tube forming clamp of claim 23, wherein:
said inner curved receiving areas of said outer receiving members being directed in a direction perpendicular to a line defining a turning radius of said base member.

25. The tube forming clamp of claim 24, wherein:
said inner curved receiving areas of the inner-receiving member being directed in a direction opposite of said outer receiving members.

26. The tube forming clamp of claim 25, wherein said hose receiving members and said base member being a single integral piece.

27. The tube forming clamp of claim 26, wherein said single integral piece including said hose receiving members and said base member being a plastic.

28. The tube forming clamp of claim 25, comprising said inner receiving members being engaged approximately center of a desired turning radius of said base member.
